(19) United States
(12) Patent Application Publication
(10) Pub. No.: US 2012/0108215 A1
(43) Pub. Date: May 3, 2012

(54) REMOTE NOTIFICATION DEVICE

(76) Inventor: Nader Kameli, Hugo, MN (US)

(21) Appl. No.: 12/916,134

(22) Filed: Oct. 29, 2010

(51) Int. Cl. H04M 1/663

(52) U.S. Cl. 455/412.2

(57) ABSTRACT

A remote notification device and various mounting configurations for notifying a user of an incoming call or message to a mobile communication device are described. In an example, a receiver is coupled to a housing. The receiver receives a notification signal from a mobile communication device. The receiver is the only communication with the remote notification device. The remote notification device is in unidirectional communication with the mobile communication device. An indicator is coupled to the housing. The indicator indicates receipt of the notification signal to a user of the remote notification device. The mobile communication device is remote from the remote notification device.

### FIELD

This application relates to an apparatus and system for notifying a user of an incoming call or message to a mobile communication device and, more particularly, to a remote notification device that is separate or separatable from a mobile communication device.

### BACKGROUND

Mobile communication devices such as mobile, cell or smart phones, personal digital assistants and tablet or notebook computers are commonly used by a large segment of the population on a daily basis. These devices are typically carried in a pocket or handbag or clipped to a belt of a user. In some situations, it can be inconvenient to carry the mobile communication device because of the size and weight of the mobile communication device. For example, a child may not want to carry a large mobile phone as it may interfere with their activities.

Incoming calls or messages to mobile communication devices typically trigger the mobile communication device to activate a vibration mechanism or cause a speaker to generate a ring tone that alerts the user to the incoming call.

Some research has tied cellphone use to rises in brain damage, cheek cancer and malfunctioning sperm. Some mobile telephone manuals recommend that the mobile telephone remain at least about an inch from the user's body. Science has shown that children and teenagers are particularly susceptible to cellphone radiation, raising questions about its effects on coming generations.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

In an example, a remote notification device can include a housing and a receiver coupled to the housing. The receiver receives a notification signal from a mobile communication device, the receiver being the only communication with the remote notification device wherein the remote notification device is in unidirectional communication with mobile communication device. An indicator is coupled to the housing. The indicator indicates receipt of the notification signal to a user of the remote notification device with the mobile communication device being remote from the remote notification device.

In an aspect of the present disclosure, the remote notification device can include the receiver receiving a display signal that includes information representing a display on the mobile communication device. The display on the mobile communication device can be remote from the notification device. The housing includes a notifying display that uses the display signal to display at least some of the same information as displayed on the display of the remote mobile communication device. The remote notification device can include the notifying display showing the same image as shown on the display of the mobile communication device. The notifying display is free from interactive controls with the user in an aspect of the present invention.

In an aspect of the present invention, the remote notification device can include the housing positioned outside a garment with the mobile communication device being within the garment. The remote notification device can include the housing having a power source, and wherein the power source includes at least one of a rechargeable battery, a replaceable battery, a power input to connect to an external power supply, an inductive power source, and a kinetic power source. The remote notification device can include the housing having a switch to program the device to link to the mobile communication device. The remote notification device can include the housing having a connector to affix to a wearable garment, and wherein the garment includes at least one of a shirt, pants, and eyeglasses. The remote notification device can include the indicator having a vibration device that can be sensed by a user. The remote notification device can include the indicator having an audio tube connecting to a wearer's ear. The remote notification device can include the housing having a watch to indicate time. The remote notification device can include the housing being remote from the mobile communication device, preferably at least inches away from the mobile communication device and at most tens of feet from the mobile communication device. The remote notification device can include the housing having overall dimensions that are less than 1.5 inches along any axis. The housing includes a structure or means that can be worn or carried inconspicuously by a use, for example, but not limited to at least one of a hairclip, necklace, hearing aid, eyeglasses, analog watch, digital watch, cigarette lighter plug and watchband link. The indicator can include a vibration device that has several vibration levels that can be selected by the user. The housing can include a connection device that allows the remote notification device to be attached under a garment. The housing can include a connection device that allows the remote notification device to be attached outside a garment. The housing can include a connection device that allows the remote notification device to be attached in a garment.

In an example, a remote notification device can include a mobile communication device that is adapted to receive an incoming communication. A remote communication device is coupled to and removable from the mobile communication device. A receiver is coupled to the remote communication device. The receiver is adapted to receive a notification signal from the mobile communication device. An indicator is coupled to the remote communication device. The indicator is adapted to alert a user to the incoming communication. The remote notification device can be coupled to the mobile communication device by a magnet. The remote communication device can be programmed through the mobile communication device.

In an example, a remote notification device can include an assistive device. A receiver is coupled to the assistive device. The receiver receives a notification signal from a mobile communication device. An indicator is coupled to a housing of the assist device. The indicator indicates receipt of the notification signal to a user of the assistive device. The assistive device can be a hearing aid. The assist device can be glasses. The assistive device can include a speaker and the receiver that is configured to receive a voice signal that is transmitted to the speaker.

In an example, a remote notification device can include a housing and a receiver coupled to the housing. The receiver is configured to receive a notification signal from a mobile communication device. An indicator is coupled to the housing. The indicator indicates receipt of the notification signal to a user of the remote notification device with the mobile communication device being remote from the remote notification device. A connection device is coupled to the housing. The connection device allows the user to carry the remote notification device in an inconspicuous manner. The connection device is a clip. The housing is adapted to be placed adjacent the skin of a user. The indicator can be a vibrating mechanism, e.g., a mechanical construct and an electrical construct. The indicator can be an audible tone.

In an example, a remote notification device can include a first housing and a receiver mounted in the first housing. The receiver can be configured to receive a notification signal from a mobile communication device and to transmit an indicator signal. A second housing can have an indicator mounted in the second housing. The indicator can be adapted to receive the indicator signal and to provide an alert. The first and second housings can be retained by a magnet.

In an example, a remote notification device can include a first remote notification device adapted to receive a first notification signal from a first mobile communication device and a second remote notification device adapted to receive a second notification signal from the first mobile communication device. Software operates on the system to determine which of the first or second remote notification devices has priority. An alarm is generated when the remote notification device loses the notification signal. Other features, examples, and embodiments are described below.

### BRIEF DESCRIPTION OF DRAWINGS

Embodiments are illustrated by way of example and not limitation in the figures of the accompanying drawings, in which like references indicate similar elements and in which:

FIG. 1 is a schematic diagram of a system according to an example embodiment;

FIG. 2 is a schematic view of a remote notification device according to an example embodiment;

FIG. 3 is a side view of the remote notification device of FIG. 2;

FIG. 4 is a schematic diagram of a remote notification device according to an example embodiment;

FIG. 5A is a side view of a remote notification device clipped to a clothing garment according to an example embodiment;

FIG. 5B is a schematic view of a remote notification device integrated into a clip according to an example embodiment;

FIG. 5C is a schematic view of a remote notification device with a clip according to an example embodiment;

FIG. 6 is a schematic view of a remote notification device mounted to an eyeglass frame according to an example embodiment;

FIG. 7 is a schematic view of a remote notification device mounted to an earpiece according to an example embodiment;

FIG. 8A is a schematic view of a remote notification device mounted in a watch according to an example embodiment;

FIG. 8B is a schematic view of a remote notification device mounted in a watch according to an example embodiment;

FIG. 9 is a schematic view of a remote notification device mounted to a watch according to another example embodiment;

FIG. 10 is a flow chart of a method according to an example embodiment;

FIG. 11A is a front view of a mobile communication device with an integrated removable remote notification device according to an example embodiment;

FIG. 11B is a back view of a mobile communication device with an integrated removable remote notification device according to an example embodiment;

FIG. 11C is a front view of a remote notification device according to an example embodiment;

FIG. 11D is a front view of a mobile communication device with an integrated removable remote notification device according to an example embodiment;

FIG. 12 is a schematic view of a remote notification device/eyeglass system according to an example embodiment;

FIG. 13 is a schematic view of a remote notification device mounted to a necklace according to another example embodiment;

FIG. 14 is a schematic view of a remote notification device mounted to a hairclip according to another example embodiment;

FIG. 15 is a side view of a remote notification device having a detachable indicator according to an example embodiment;

FIG. 16 is a schematic view of a remote notification device mounted to a cigarette lighter plug according to another example embodiment;

FIG. 17 is a schematic view of system with multiple remote notification devices according to another example embodiment; and

FIG. 18 is a schematic view of a remote notification device.

### DETAILED DESCRIPTION

Example apparatuses, devices, methods and systems are described. In the following description, for purposes of explanation, numerous specific details are set forth in order to provide a thorough understanding of example embodiments. It will be evident, however, to one skilled in the art that the present invention can be practiced without these specific details.

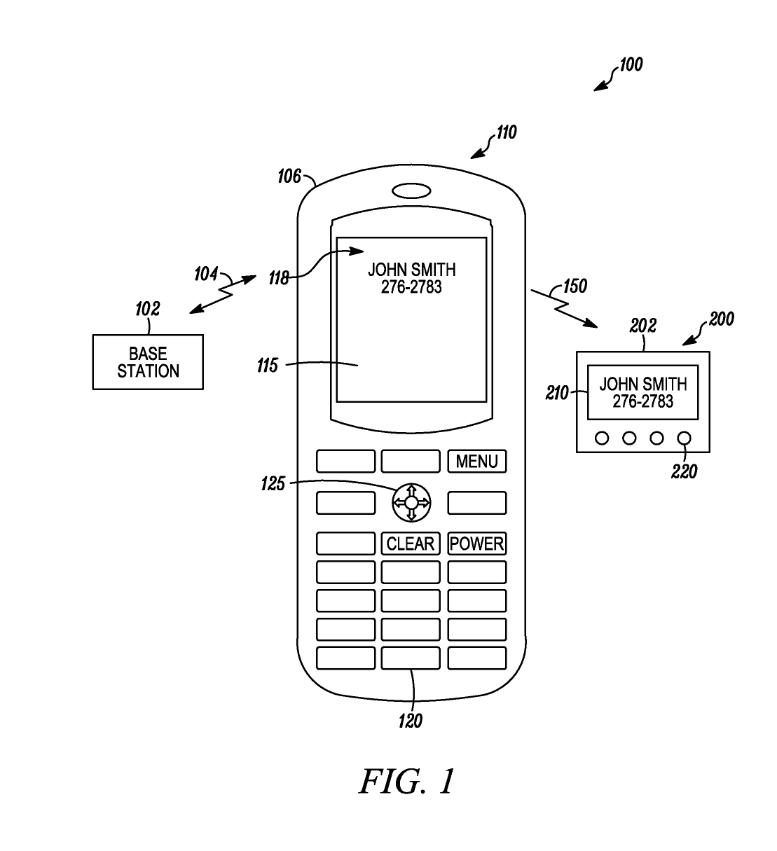

FIG. 1 illustrates an example communication system 100 which can include a base station 102 that can communicate with a plurality of mobile communication devices 110 via a wireless or RF signal 104. Mobile communication device 110 can, in various embodiments, be anyone of a wide variety of devices such as mobile telephones or cell phones, personal data assistants, laptop computers, email devices, pagers, tablet computers or notebook computers, etc. These devices provide various means of communication. In an example, device 110 can be a mobile phone and can communicate using electromagnetic radiation in the microwave range to encode data. Base station 102 and mobile communication device 110 can be in bi-directional communication thorough a variety of communication standards, protocols and systems. Examples include any wireless network capable of communicating between systems including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network.

Mobile communication device 110 includes a housing 106. Mounted in housing house are a display 115 that is viewable outside the housing, a plurality of input keys 120 and a scroll device 125, which are both accessible from outside the housing. Display 115 can display a wide variety of information 118 to a user. For example, display 115 can display the name and phone number of an incoming phone call. The display 115 can include a tactile sensor integrated with the visual display element to provide input and output to the mobile communication device. Examples of displays include active displays and passive displays. Passive displays include liquid crystal display. Active displays can include a backlit, liquid crystal display. Other types of displays include light emitting diode displays.

Communication system 100 includes a remote notification device 200 that can receive communications from the mobile communication device 110 via a notification signal 150. Remote notification device 200 includes a housing 201. Mounted in housing 202 are an indicator device 210 such as a notification display and input devices 220. The display can include active displays and passive displays. Passive displays include liquid crystal display. Active displays can include a backlit, liquid crystal display. Other types of displays include light emitting diode displays. The indicator device can also include a speaker for sounding a sequence of tones or music, or a buzzer or beeper for sounding a predetermined tone.

Mobile communication device 110 can transmit notification signal 150 to notification device 200 using a radio frequency, magnetic or electromagnetic, or optical signal. Various communication standards can be used. Examples include IEEE 802.11 series, Bluetooth, IEEE 802.16 series, Zigbee and infrared. Other conventional and/or later developed communication standards may also be used. In an example, the Bluetooth wireless standard for exchanging data over short distances is used. Notification signal 150 is a one way or unidirectional signal from mobile communication device 110 to remote notification device 200. That is, the notification signal 150 is only transmitted by mobile communication device 110 and received by the notification device 200. In an aspect, the notification device 200 does not have transmission ability such that it can not send data or information to the mobile communication device 110. The remote notification device 200 is in unidirectional communication with the mobile communication device 110 using a bidirectional or unidirectional communication protocol. Mobile communication device 110 can be programmed to transmit notification signal 150 upon receipt of an RF signal 104 that contains an incoming call or message, e.g., a SMS text message or MMS text message. Mobile communication device 110 can be programmed to transmit notification signal 150 upon a need to alert the user, for example, an alarm, at a certain time, or other reminder from the mobile communication device. Mobile communication device 110 can further be programmed to suppress any of the alerting mechanisms that are associated with mobile communication device 110 upon receipt of an RF signal 104 that contains an incoming call or message. In an example, the generation of a ring tone and vibration mechanism in mobile communication device 110 are disabled upon receipt of an RF signal 104 that contains an incoming call or message. In an example, the notification signal 150 replaces the ring tone, ring signal, or vibration of the mobile communication device 110. In an example, the notification signal 150 when turned on automatically turns off the on-device notifiers of the mobile communication device 110. Notification device 200 can be programmed to automatically establish communication with mobile communication device 110 when notification device 200 is turned on.

In another example, remote notification device 200 has both a transmitter and a receiver such that signals can be sent back and forth between remote notification device 200 and mobile communication device 110. Remote notification device 200 can be programmed to transmit an instruction signal, commands or fixed voice packets to mobile communication device 110. For example, when a user is temporarily busy, remote notification device 200 can send a signal to mobile communication device 110 to answer the call and send a voice message to the caller to please hold and then to put the call in a hold mode. Mobile communication device 110 can be programmed to receive the instruction signal and take the required action.

Notification signal 150 can contain a wide variety of data and information. In an example, notification signal 150 can contain a display signal that has same data that is shown on display 115 of mobile device 110. In one example, notification signal 150 can contain a display signal with a subset of the data shown on display 115 of mobile device 110. In another example, notification signal 150 can contain a display signal with additional data that is not shown on display 115 of mobile device 110. Examples of the data in the notification signal can be any of the following group, either singly or in any combination, call received, telephone number of the caller, name of the caller, information regarding call history, time of call, and/or information related to notification signal such as reason for the notification (alarm or appointment). The data examples can also apply to text messages.

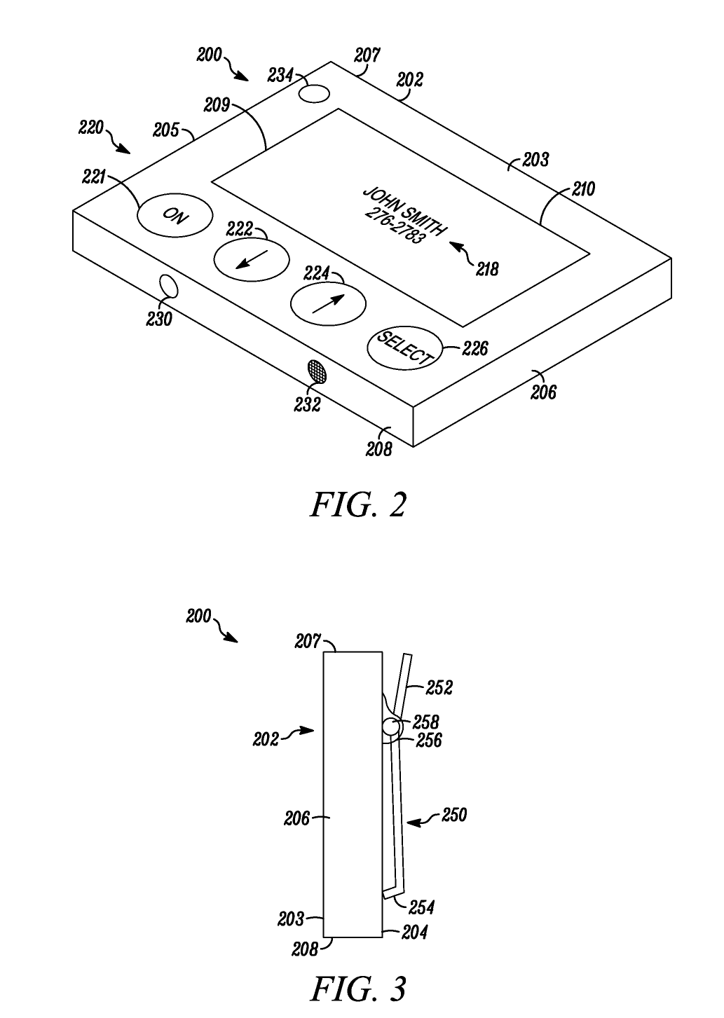

FIGS. 2 and 3 illustrate additional features of remote notification device 200. Remote notification device 200 includes a generally rectangular housing 202 that has a front side or surface 203, back side or surface 204 and sides 205, 206, 207 and 208. Housing 202 can have a variety of shapes such as square, rectangular, round or any other attractive shape. Housing 202 can be formed from suitable materials such as metal or plastic. It is desirable that housing 202 have a small overall size such that remote notification device 200 can be worn or carried in an inconspicuous manner. In an example, housing 202 may have dimensions of length, height and width that are all less than 1.5 inches. The housing 202 encloses electronic components that provide functionality to the device 200. In an example, the electronic components receive the notification signal and cause the device 200 to emit its own notification signal. In an example, the electronic components include music or audio playing circuits, which can include an input to load audio data onto the device 200, encoder/decoders to produce audio, and an output to play the audio for the user. In an example, the input can be a serial input, a universal serial bus, Apple™ input, Ethernet, Firewire, or other I/O port. In an example, the output can be a registered jack, RCA jack or other jack adapted to receive a plug from a speaker or headphones. In an example, the electronic components include memory, such as microdrive hard drives made by Hitachi Ltd. (Kabushiki Kaisha Hitachi Seisakusho) of Tokyo, Japan or Seagate of Scotts Valley, Calif., USA. Microdrive hard drives can be composed of compact flash memory, e.g., CompactFlash II. The housing 202 is formed of a material that is durable so that it lasts an acceptable time when in use by a user while protecting the internal components from environmental contaminants. In an example, the housing 202 is a metal, such as aluminium. In an example, the housing 202 is a polymer.

Indicator or notification display 210 can be mounted in housing 202 such that it is visible through opening 209. Notification display 210 uses a suitable display technology such as a liquid crystal display (LCD), light emitting diode (LED), organic light emitting diode (OLED), plasma, electroluminescent or other suitable display technologies. Display 210 can display a wide variety of notification information 218 to a user. In an example, display 218 can indicate the name and phone number of an incoming phone call, data related to an incoming text message or other alert from the mobile communication device. In an example, display 210 contains the same information as shown on display 115 (FIG. 1) of the mobile communication device. In an example, the display 210 contains a subset of the information that is shown on the display 115 of the mobile communication device.

Another indictor such as a light 234 is mounted to the front side 203 of housing 202. Light 234 can be a light emitting diode or other light source. Light 234 can be flashed to indicate an incoming call. In an example, light 234 can be omitted. Light 234 can be controlled by the electronic circuits in the notification device 200. The light 234 can be programmed to illuminate a pattern based on the incoming call number, name, other identification data to the mobile communication device. In an example, the light 234 illuminates a different pattern based on the type of notification, e.g., a call illuminates a first pattern, a text message illuminates a second pattern, an alert (e.g., alarm, reminder programmed into the mobile communication device, etc.) illuminates a third pattern, and other notifiers from the mobile communication device illuminates a fourth pattern. As a result the user can recognize the type of notification and type of information from the mobile communication device based on the light pattern produced by the remote notification device 200.

Remote notification device 200 further includes several input devices 220. Input devices 220 can be switches, keys, buttons, joysticks, touch pads or other suitable input devices. Input devices 220 include an on/off button 221, an up button 222, a down button 224 and a select button 226. On/off button 221 allows a user to turn power on and off to remote notification device 200. Pressing button 221 turns device 200 on. Pressing button 221 again turns device 200 off. Up button 222 allows a user to scroll through a menu shown in notification display 210. Down button 224 allows a user to scroll through a menu shown in notification display 210. Select button 226 allows a user select items or options shown on notification display 210. For example, buttons 222, 224 and 226 can be used to select which cell phone a notification signal is received from, select the type of alerting mode; sound, light, vibration, display or any combination thereof, select the volume or intensity of the alerting mechanism, disconnect from the cell phone and to stop or silence an alert. The buttons can further be used to program different types of notifications to be emitted by the notification device depending on the type of notification from the mobile communication device. The different types of notification can includes combinations of physical (e.g., vibration patterns), audio, and visual patterns that can uniquely identify the type of notification from the mobile communication device or uniquely identify the origin of the communication. In an example, the buttons 222-226 act as switches that are used for programming different features in the device using various sequences of press/release in conjunction with or without time delays. Alternatively, input devices 220 or buttons 222-226, individually, may be omitted in one example. The settings of remote notification device 200 can then be pre-programmed, e.g., to match a particular mobile communication device. In another example, the operational settings of remote notification device 200 can be transmitted along with or as part of notification signal 150.

The buttons on the remote notification device 200 can be variously incorporated into a scroll wheel with auxiliary button adjacent the scroll wheel. In an example, only five buttons are provided and accessible outside the housing. These buttons can perform various tasks depending on a current mode the remote notification device. In an example, a button is positioned in the center of the scroll wheel with the other four buttons orthogonally positioned around the scroll wheel.

A plug-in connector 230 is mounted to side 208. plug-in connector 230 can be mated with an electrical cable (not shown) in order to connect with another electrical device, such as a power source for charging a rechargeable battery in remote notification device 200 or another electrical device, such as a computer. The electrical device can download instructions, data or software to the remote notification device 200. The instructions can be machine readable instructions that the device 200 can use to provide operational functions. The data can be machine readable data that interact with the device and/or instructions to provide operational parameters for the device 200. Examples, of connector 230 can be universal serial bus, Firewire™, IEEE 1394, USB 2.0, serial connector, ethernet, connections and related communication protocols.

Another indicator such as speaker 232 provides an audio signal or announcement to a user. Speaker 232 can provide a ring tone or other audible signal to indicate an incoming call. Another indicator such as a vibrating mechanism (not shown) can be mounted within housing 202 to provide a vibration signal or announcement to a user of an incoming call or message.

With reference to FIG. 3, a connection device 250 is mounted to back side 204 of housing 200. Connection device 250 can be any suitable mechanism for making a connection such as for example, but not limited to, a clip, pin, fastener, Velcro or other connection device. In an example, connection device 250 is a spring loaded clip that includes a grasping end 252, central portion 253, clamping end 254, retainer 256 and spring 258. Connection device 250 extends generally parallel and closely to back side 204 such that remote notification device 200 has an overall slim profile. Grasping end 252 is angled slightly away from back side 204. Retainer 256 affixes connection device 250 to back side 204 of housing 200. A user may apply pressure using their fingers between housing 200 and grasping end 252 causing grasping end 252 to move toward back side 204, spring 258 to be compressed and clamping end 254 to move away from back side 204, thereby creating an opening between clamping end 254 and back side 204. Clamping end 254 is then placed over the item that is desired to be attached with and grasping end 252 released. Spring 258 biases clamping end 254 into contact with the item to be attached with.

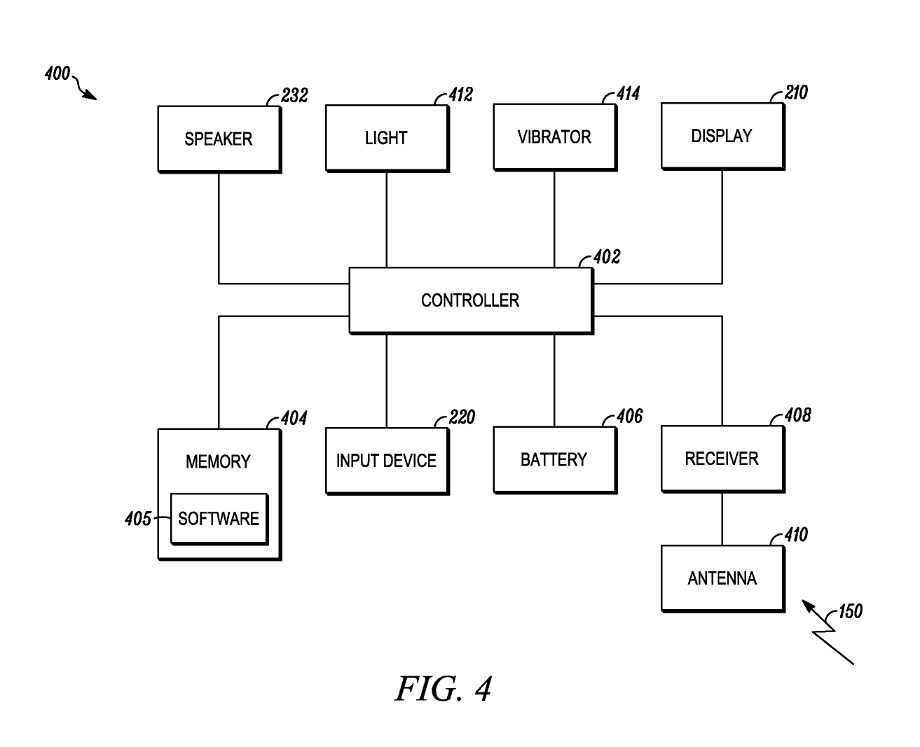

FIG. 4 illustrates a schematic diagram 400 of remote notification device 200. Remote notification device 200 includes a processor or controller 402 that controls the operation of remote notification device 200. Controller 402 can be a microcontroller, microprocessor, field programmable gate array or an application specific integrated circuit. One or more instructions, instruction sets or software 405 can be stored on a machine-readable medium or memory 404 embodying any one or more of the methodologies or functions described herein. Memory 404 can be a non-volatile memory, random access memory (RAM), read only memory (ROM), programmable memory (PROM) or any other suitable memory. Software 405 may also reside, completely or at least partially, within any memory contained within controller 402 during execution thereof by the remote notification device 200. Software 405 can store various user options and operating modes that operate on controller 402.

The term “memory or machine-readable medium” shall also be taken to include any medium that is capable of storing, encoding or carrying out a set of instructions for execution by the processor and that cause the processor to perform any one or more of the methodologies shown in the various embodiments of the present invention. Machine-readable medium or memory shall accordingly be taken to include, but not be limited to, solid-state memories, and optical and magnetic media. It will be further recognized that data that can be read by a machine can be in the form of signals, e.g., propagating in wires, in light, in sound, or other machine controlled environments, or embedded in carrier wave signals.

A battery 406 is connected to controller 402 and other components in order to supply power to remote notification device 200. Battery 406 can be rechargeable. Battery 406, in another example, can be non-rechargeable and, hence, require replacement. Battery 406 can be a lithium ion battery, nickel metal hydride, nickel cadmium or any other suitable type of battery. Battery 406 is charged using connector 230 (FIG. 2) that mates with a charging unit (not shown). In an example, a pair of surface mounted conductive pins can be mounted to housing 202 (FIG. 2) instead of connector 230 in order to charge battery 406. In another example, a wireless charging mechanism is used with an inductive antenna coupled to battery 406 and an exterior charger unit that transmits energy through electromagnetic coupling to battery 406. In an example, power can be supplied to battery 406 by connecting battery 406 with mobile communication device 110 (FIG. 1). In other embodiments, power can be supplied to battery 406 using solar cells. In another embodiment, power can be supplied to battery 406 using a kinetic mechanism that generates charge through motion. In another example, battery 406 can be charged using energy from mobile communication device 110 through a connector.

Controller 402 is in communication with receiver 408. Receiver 408 is connected with an antenna 410. Receiver 408 contains an electronic circuit that receives the notification signal 150, provides signal conditioning to the notification signal 150 and outputs the notification signal 150 to controller 402. In one example, notification signal 150 can be an analog signal and receiver 408 can include an analog to digital converter circuit that provides the notification signal to controller 402 in a digital format. Notification signal 150 can use a variety of communication standards. For example, Bluetooth, Zigbee and infrared. Other conventional and/or later developed communication standards may also be used. Notification signal 150 is a one way or unidirectional signal or transmission from mobile communication device 110 to remote notification device 200. Notification signal 150 can contain a wide variety of data and information. In an example, remote notification device 200 can be remote from the mobile communication device 110, preferably at least inches away from the mobile communication device and at most tens of feet from the mobile communication device.

In an example, remote notification device 200 has the ability to set off an alarm when remote notification device 200 travels out of range of notification signal 150 and losses connection. When the remote notification device 200 travels out of range and looses connection with mobile communication device 110, an alarm or alert is triggered. The user will then be able to silence the alert or move within range of the notification signal. When mated with a mobile communication device 110, the remote notification device 200 can periodically receive a signal from the mobile device communication device 110. In an example, device 110 is a cellular telephone that periodically broadcasts a signal to maintain communication with either the device 200 or the base station 102. The device 200 can sense this signal and determine that it is in range of the device 110.

Input devices 220 are in communication with controller 402. Input devices 220 can be switches, keys, buttons, joysticks, touch pads or other suitable input device. Input devices 220 allow a user to control the operation of remote notification device 200 and to select various operating modes and features from a selection menu shown on notification display 210. The input device(s), e.g., a switch, can be used for programming different features in the device 200. The input device can require various sequences of press/release in conjunction with time delays to input data into the device 200 or to program the device 200.

Controller 402 is also in communication with several indicator components that signal an incoming call to a user. Controller 402 is in communication with indicators including speaker 232, light 234, vibrator 414 and notification display 210. Controller 402 can be a low power central processing unit or a device-dedicated low power processor.

A user can select which one or all of the alerting components are used to signal an incoming call using input devices 220 and a menu shown on notification display 210. When notification signal 150 indicates an incoming call, controller 402 can cause notification display 210 to display the name and phone number of the incoming call. Other data about the incoming call may also be displayed. If the incoming call is a SMS text message, the message can be displayed. When an incoming call is detected, controller 402 can flash light 234. Light 234 can be a light emitting diode or other lighting device. Controller 402 can cause speaker 232 to generate an audio signal or announcement to a user when an incoming call is detected. Speaker 232 can provide a ring tone or other audible signal to indicate an incoming call. Controller 402 can cause a vibrating device or vibrator 414 to generate a mechanical vibration within housing 202. Vibrator 414 is a mechanical or piezoelectric vibration mechanism that couples vibrations to housing 202 such that a user holding or carrying remote notification device 200 can sense the vibrations generated by vibrator 414. Vibrator 414 can include an electronic control circuit and a mechanical structure that creates a vibration. Vibrator 414 can provide a noiseless signal to a user to indicate an incoming call. Vibrator 414 can have several levels of vibration intensity that are selected by the user. For example, vibrator 414 can be placed on a high setting when the remote notification device is placed inside a handbag and vibrator 414 can be placed on a low high setting when the remote notification device is placed on the outside of a garment.

The components that make up remote notification device 200 can be assembled on a printed circuit board (not shown) using conventional electronic assembly techniques.

Two or more remote notification devices 200 can be located in the same area and can be programmed or assigned different priorities. That is, a first remote notification device has a higher priority than a second remote notification device. In an example, a first remote notification device can be associated with a vehicle mobile communication device and have a higher priority over a second remote notification device that is associated with a portable mobile communication device. In the vicinity of the vehicle, the first remote notification device is functional and the second remote notification device is disabled. If the second remote notification device is removed from the vicinity of the vehicle, the second remote notification device can become functional and resume normal operation. Each of the multiple notification devices has the ability to register with an associated mobile communication device.

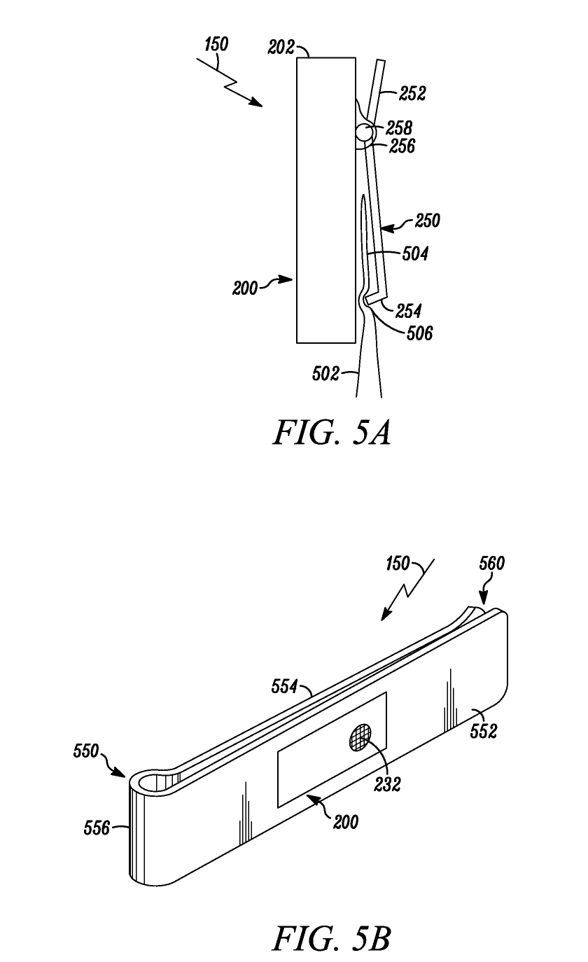

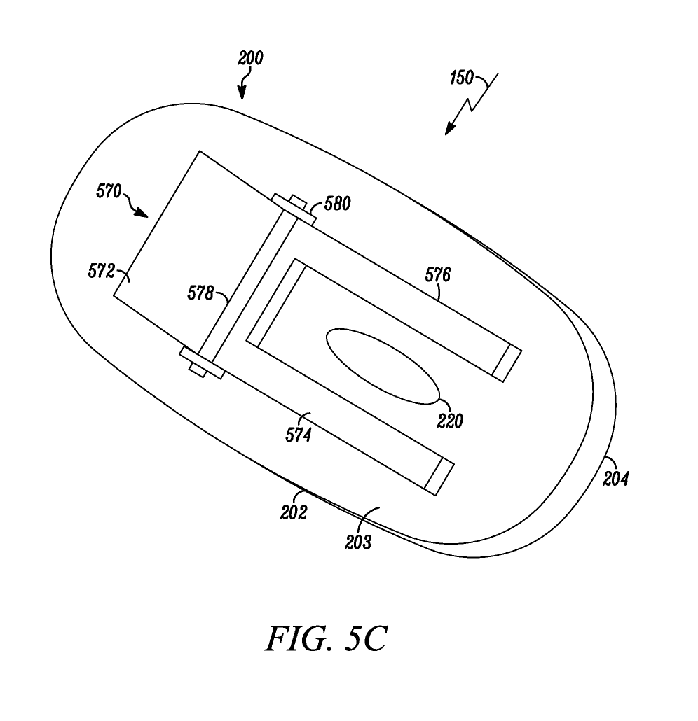

FIG. 5A illustrates remote notification device 200 clipped to a clothing garment 502. Clothing garment 502 can be any piece of clothing or accessory such as pants, shirt, belt, socks, hat, shoes, scarf, coat, underwear, bra, necklace, handbag, etc. Clothing garment 502 has a folded end, edge or seam 504 that is retained by connection device 250. Clothing garment 502 is held between clamping end 254 and back side 204 in a crimped or retention area 506 by the spring force of spring 258. A user may apply pressure using their fingers between housing 200 and grasping end 252 causing grasping end 252 to move toward back side 204, spring 258 to be compressed and clamping end 254 to move away from back side 204, thereby creating an opening between clamping end 254 and back side 204 such that edge 504 can be either inserted or removed. In this manner, remote notification device 200 can be attached or detached from a clothing garment. Remote notification device 200 and connection device 250 have a low profile such that they can be mounted close to the skin of a user in a hidden manner. Remote notification device 200 can be placed in contact with the skin such that one side of housing 200 is in contact with the skin and may receive vibrations from vibrator 414.

While FIG. 5A illustrates the remote notification device 200 as clipped to a clothing garment 502, it is within the scope of the present invention to place the device 200 in a pocket specially designed for the device 200. The device 200 can be enclosed in the pocket. In another example, the device 200 is integrated into a garment, e.g., sewn into the garment.

FIG. 5B illustrates another remote notification device 200 integrated into a clip 550 that can be attached in an invisible manner to a clothing garment adjacent the skin of a user. The clothing garment can be any piece of clothing or accessory such as pants, shirt, belt, socks, hat, shoes, scarf, coat, underwear, bra, necklace, handbag, etc. Clip 550 has arms 552 and 554 that extend parallel to each other and are joined at a bend 556. A space 560 is formed between arms 552 and 554. Clip 550 may be formed from a suitable material such as metal or plastic. Arms 552 and 554 may be expanded to fit over or onto a clothing garment such that the clothing garment is clamped between arms 552 and 554. In this manner, remote notification device 200 can be attached or detached from a clothing garment or directly to a wearer's body, e.g., hair. In the remote notification device 200 of FIG. 5B, the display and input devices have been omitted in order to provide a more compact and invisible package. Remote notification device 200 is mounted in arm 552 and contains a speaker 232. The speaker can sounding a sequence of tones or music, or a buzzing or beeping sound at a predetermined tone. Remote notification device 200 can contain a vibration mechanism 414 (FIG. 4). Clip 550 and remote notification device 200 have a low profile such that they can be mounted close to the skin of a user in an invisible manner. In an example, clip 550 and remote notification device 200 can be attached to a bra or underwear of a user where they would be undetectable to others who are in view of the user. That is, the user could receive a notification and other's around the user cannot see the device 200. Clip 550 and remote notification device 200 can be worn under the clothing of a user in an inconspicuous manner such that the user can be alerted to an incoming call or text in a covert manner. In an example, clip 550 may have dimensions of length, height and width that are all less than 1.5 inches.

Clip 550 and remote notification device 200 can provide the illusion that a user is not carrying or using a mobile phone, when in reality they can be notified of an incoming call or message at any time. Clip 550 can be placed such that arm 552 is adjacent the skin of the user and may receive vibrations from the vibration mechanism. Alternatively, arm 554 may be placed adjacent the skin of the user such that speaker 232 can be readily heard during use. In another example, speaker 232 can be omitted. Remote notification device 200 of FIG. 5B can have user selections that are programmed through mobile communication device 110 (FIG. 1). In another example, remote notification device 200 can be integrated into a garment or accessory such as being sewn into the garment or in the strap of a handbag.

FIG. 5C illustrates remote notification device 200 mounted to a connection device 570 such as a clip. Clip 570 can be attached to a clothing garment or any piece of clothing or accessory such as pants, shirt, belt, socks, hat, shoes, scarf, coat, underwear, bra, necklace, handbag, etc. Clip 570 can include a central body portion 572 from which a pair of parallel arms 574 and 576 extend. Clip 570 can rotate about a spring 578. Clip 570 is retained to housing 202 by a retainer 580. Arms 574 and 576 can move toward and away from housing side 203. A clothing garment can be held or clamped between arms 574, 576 and housing side 203. In this manner, remote notification device 200 can be attached or detached from a clothing garment. Input device 220 such as a button is located on side 203 between arms 574 and 576. Remote notification device 200 and clip 570 have a low profile such that they can be mounted close to the skin of a user in a hidden manner. Remote notification device 200 can be placed in contact with the skin such that side 204 is in contact with the skin and side 203 faces outwardly away from the user. In this configuration, input device 220 is accessible to a user to turn on remote notification device 200 or to silence an alert. In the remote notification device 200 of FIG. 5C, the display and speaker have been omitted in order to provide a more compact and invisible package. Remote notification device 200 can contain a vibration mechanism 414 (FIG. 4). Alternatively, remote notification device 200 of FIG. 5C can include a speaker. Remote notification device 200 and clip 570 can be placed in a specially designed pocket. In another example, the remote notification device 200 and clip 570 are integrated into a garment.

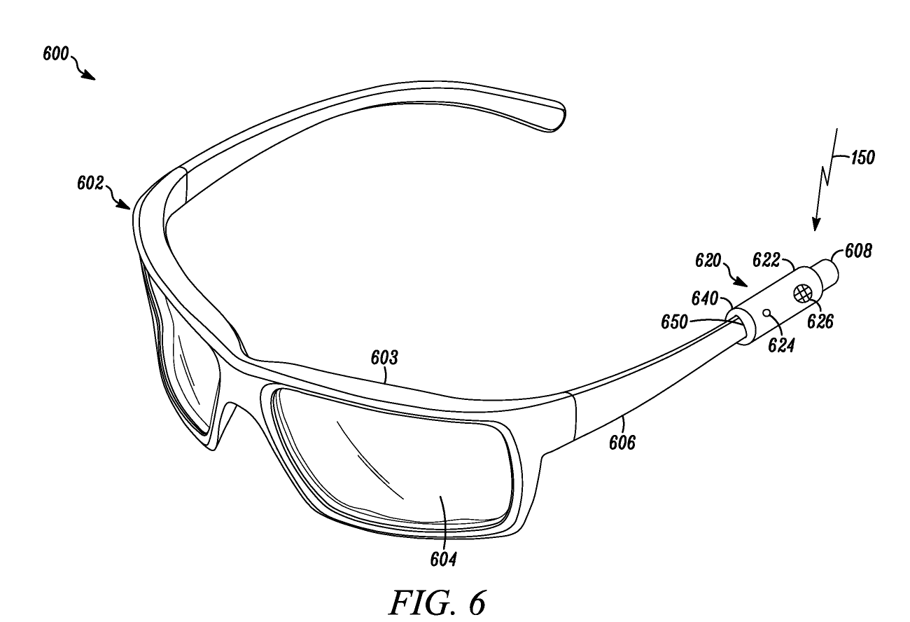

FIG. 6 illustrates an eyeglass assembly 600 having a remote notification device 620 mounted to an eyeglass frame 602. Eyeglass frame can be any of the following types of specialized frames: bifocals, sunglasses, auxiliary frames, fit-over glasses, prescription glasses, safety glasses, swim masks, ski goggles, sports goggles, and other goggles. Eyeglass frame 602 contains a pair of lenses 604, rim 603, temples 606 and temple ends 608. Remote notification device 620 has a housing 622. Housing 622 includes a flange 640 with an opening or bore 650. Flange 640 can be press fit over temple end 608 such that temple end 608 extends through bore 650 and past the bore 650. Flange 640 can be formed from an elastic material such that flange 640 can conform to a variety of temple sizes. In another example, housing 622 can cover temple end 609. In this manner, remote notification device 620 can be removably retained to one of temples 606. Remote notification device 620 includes an input device or button 624 and a speaker 626. Remote notification device 620 can be similar to remote notification device 200 except that remote notification device 620 has no display. In an example, remote notification device 620 can have a smaller size than remote notification device 200. It is desirable that housing 622 have a small overall size such that it is not readily visible. In an example, housing 622 may have dimensions of length, height and width that are all less than 1.5 inches.

Remote notification device 620 can operate in the same manner as previously described for remote notification device 200. When remote notification device 620 receives a notification signal 150 indicating an incoming call, remote notification device 620 can signal the eyeglass wearer to the call using one or more of an audio or vibration signal.

In an example, the remote notification device 620 includes a media player and an interface for electronically providing media to the media player. The device 620 can include software and hardware that enables real-time user-control to configure media player operation.

In an example, the remote notification device 620 is integrated into the frame 602, e.g., into the temples 606. The circuits that form the functional components of the device 620 are within the temples or other parts of the frame. The temples 606 can define a volume sufficient to hold or enclose all of the circuits and other components needed for the remote notification device. The temples can have a tapered profile, e.g., they can be wider and/or broader at the end closest the lens holders. Toward the rear temple end 608 the temple is reduced in size, e.g., narrower. In an embodiment, a wider or broader temple requires that the temple spans encompass a larger area or volume. Thus, this exemplary device 602 has a streamlined appearance and looks more like normal eyeglasses than the remote notification device 620 illustrated in FIG. 6. The display can be at the side of one of the temples. However, a user would need to remove the glasses to view the display. Any buttons on the device 620 can be on the interior (relative to the user) so that the exterior has a smooth exterior appearance to resemble normal eyeglasses.

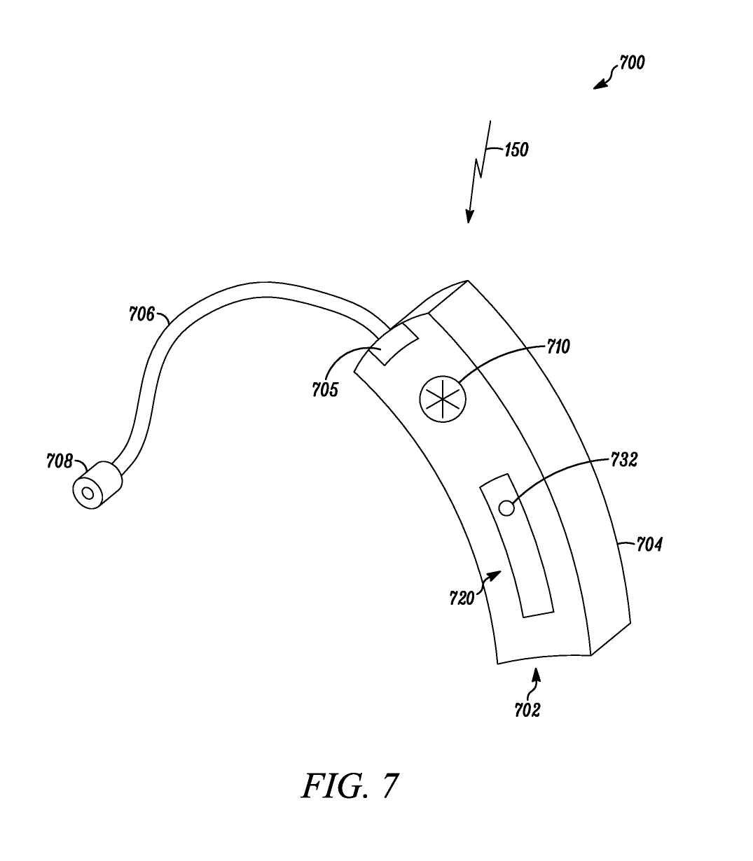

FIG. 7 illustrates an earpiece assembly 700 having a remote notification device 720 mounted in an earpiece 702. Earpiece 702 includes a housing 704 and an ear canal portion 708 and an audio tube 706. Earpiece 702 may be worn behind the ear of a user with audio tube 706 extending into an ear canal of the user. Remote notification device 720 can be mounted in housing 704. A speaker 705 is mounted in housing 704 and is in audible communication with audio tube 706. The sound from speaker 705 travels along audio tube 706 to the user. A volume control device 710 can be used to control the volume of earpiece assembly 700. Remote notification device 720 can be placed into the ear of a user in order to be alerted to an incoming call or text message. Remote notification device 720 includes an input device 732 such as a button. Remote notification device 720 can function similar to remote notification device 200 except that remote notification device 720 has no display. In an example, remote notification device 720 can be integrated with a hearing aid. When remote notification device 720 receives a notification signal 150 indicating an incoming call, remote notification device 720 can signal the earpiece wearer to the call using an audio or vibration alert. Input device 732 can be used to turn remote notification device 720 on or off or to mute or silence remote notification device 720. In an example, the receiver in remote notification device 720 can also receive voice signals or communications from mobile communication device 110 that are then played over speaker 705. A user would be able to listen to a phone conversation using earpiece assembly 700. The user would talk during the conversation in a conventional manner using mobile communication device 110.

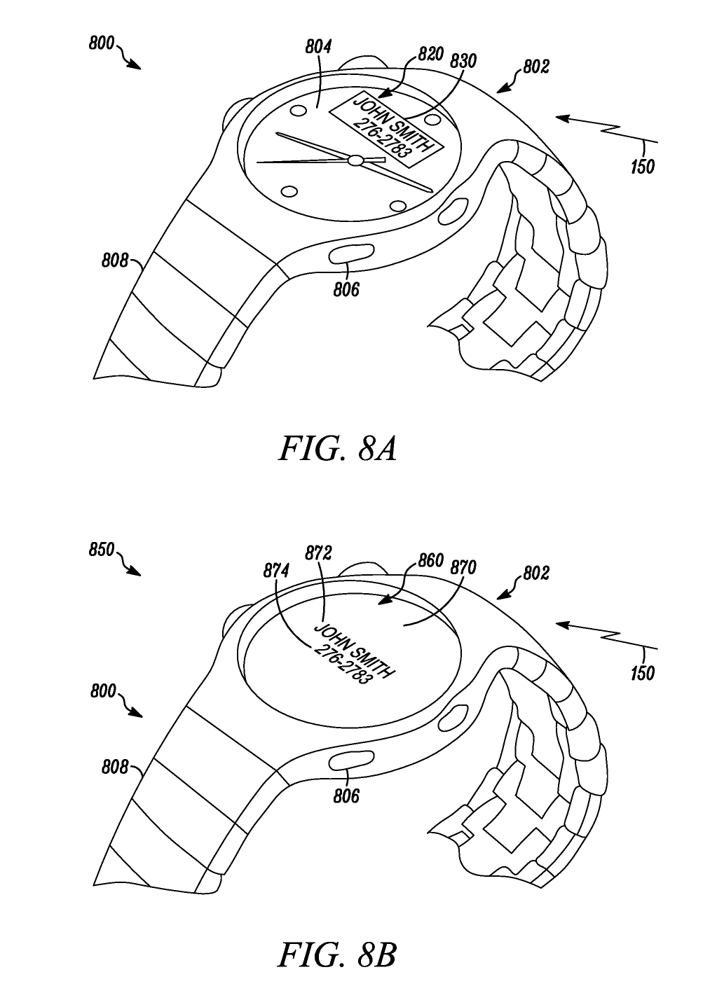

FIG. 8A illustrates an analog watch assembly 800 having a remote notification device 820 integrated into a watch housing 802. Watch housing 802 includes a dial 804, function buttons 806 and wristband 808. The watch housing 802 can be generally rigid. The wristband 808 is flexible to curve around the wearer's wrist comfortably. The watch assembly 800 can further include circuitry to keep time and display the time and/or date to a wearer, including analog circuitry. Remote notification device 820 is mounted in dial 804 with a notification display 830. Remote notification device 820 can operate in the same manner as previously described for remote notification device 200. When remote notification device 820 receives a notification signal 150 indicating an incoming call, remote notification device 820 can signal the watch wearer to the incoming call using one or more of a visual, audio or vibration alert. The caller name and number can be displayed on display 830 or a ring tone can be generated. Alternatively, remote notification device 820 can be set to vibrate watch housing 802. Function buttons 806 are used to select settings for remote notification device 820. In another example, display 830 can be omitted and remote notification device 820 is integrated into watch assembly 800.

FIG. 8B illustrates a digital watch assembly 850 having a remote notification device 860 integrated into watch housing 802. The watch assembly 850 can further include circuitry to keep time and display the time and/or date to a wearer. Watch housing 802 includes an LCD display or screen 870, function buttons 806 and wristband 808. Remote notification device 820 is integrated into the digital watch function and controlled by function buttons 806. Remote notification device 860 can operate in the same manner as previously described for remote notification device 200. When remote notification device 860 receives a notification signal 150 indicating an incoming call, remote notification device 860 can signal the watch wearer to the incoming call using one or more of a visual, audio or vibration alert. The caller name 872 and number 874 can be displayed on screen 870. Alternatively a tone can be generated or watch housing 802 can be vibrated.

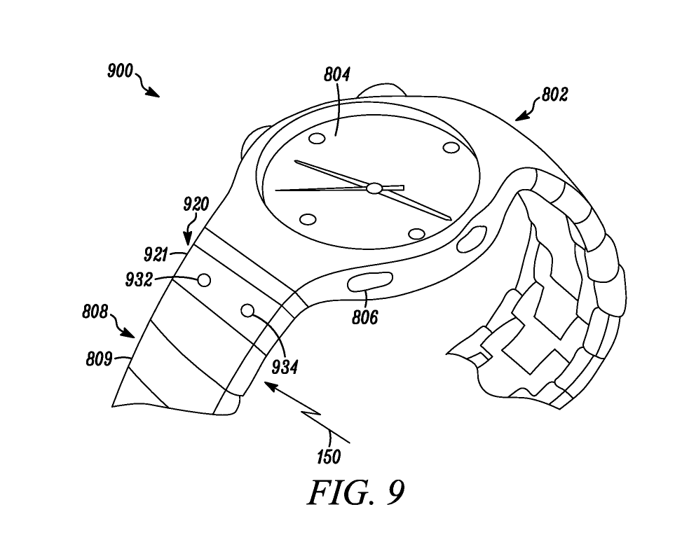

FIG. 9 illustrates a watch assembly 900 having a remote notification device 920 attached to a watch wristband 808. The watch housing 802 can further include circuitry to keep time and display the time and/or date to a wearer. Watch housing 802 includes a dial 804, function buttons 806 and wristband 808 with links 809. Remote notification device 920 has a housing 921 that replaces one of links 809 or is added onto the links 809 that are present. Housing 921 can replace one of links 809 using conventional link pins (not shown) Remote notification device 920 has a light 932 such as a light emitting diode and an input device 934 such as a button. Remote notification device 920 can operate in the same manner as previously described for remote notification device 200. In an example, remote notification device 920 can have a smaller size than remote notification device 200. It is desirable that housing 921 have a small overall size such that it is not readily visible. In an example, housing 921 may have dimensions of length, height and width that are all less than 1.5 inches.

When remote notification device 920 receives a notification signal 150 indicating an incoming call, remote notification device 920 can signal the watch wearer to the incoming call using one or more of a visual, audio or vibration alert. The caller name and number can be displayed on display 930 or a ring tone can be generated. Alternatively, Remote notification device 920 can be set to vibrate wristband 808.

Examples of watch circuitry can include those shown and described in RE41,686; U.S. Pat. Nos. 5,446,702; 4,785,436; 4,540,292; 4,308,608; 4,306,302; 4,129,981; 3,998,046; 3,733,810; and 3,668,859, which are hereby incorporated by reference for any purpose. If any document incorporated herein by reference conflicts with the present disclosure, the present disclosure controls interpretation.

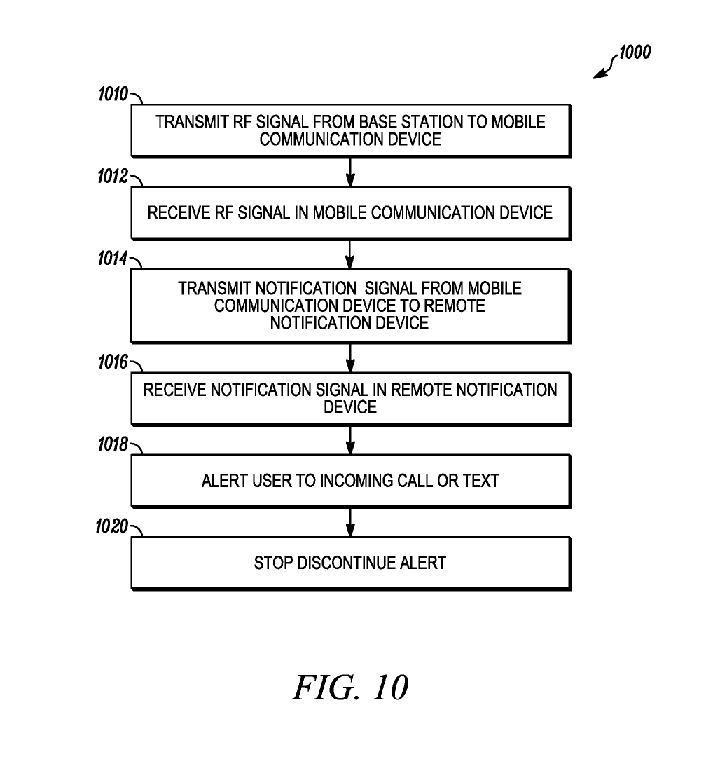

FIG. 10 illustrates a flow chart of a method 1000 for issuing an incoming call alert using the remote notification device 200 (FIG. 3). At step 1010, a conventional mobile phone call or text message is placed causing the base station to send an RF signal to the mobile communication device. The incoming call or text is received by the mobile communication device at step 1012. At step 1014, the mobile communication device is programmed to not ring or vibrate any of its own alerting mechanisms and to transmit the notification signal to the remote notification device using a short range communication protocol. The notification signal is received by the remote notification device in step 1016. At step 1018, the remote notification device alerts the user to an incoming call or message using one or more of a display, light, audio or vibrating device. A user may stop or silence the alert in step 1020 by depressing a button on the remote notification device. Alternatively, the alert may automatically be discontinued when the mobile communication device is answered or after a pre-determined period of time.

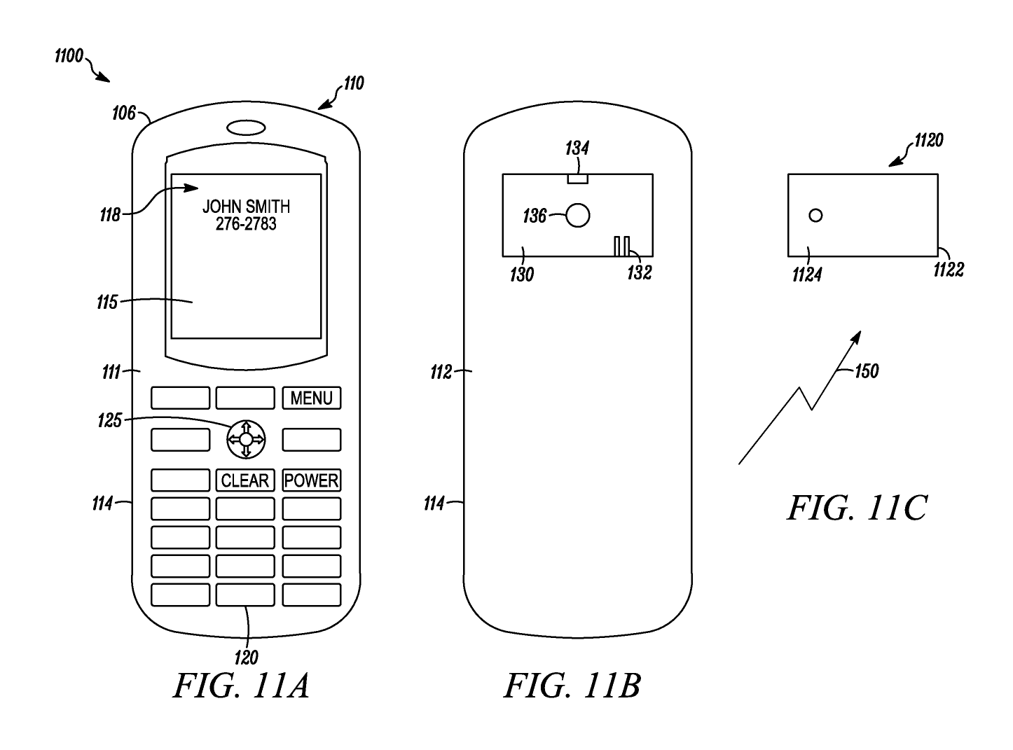

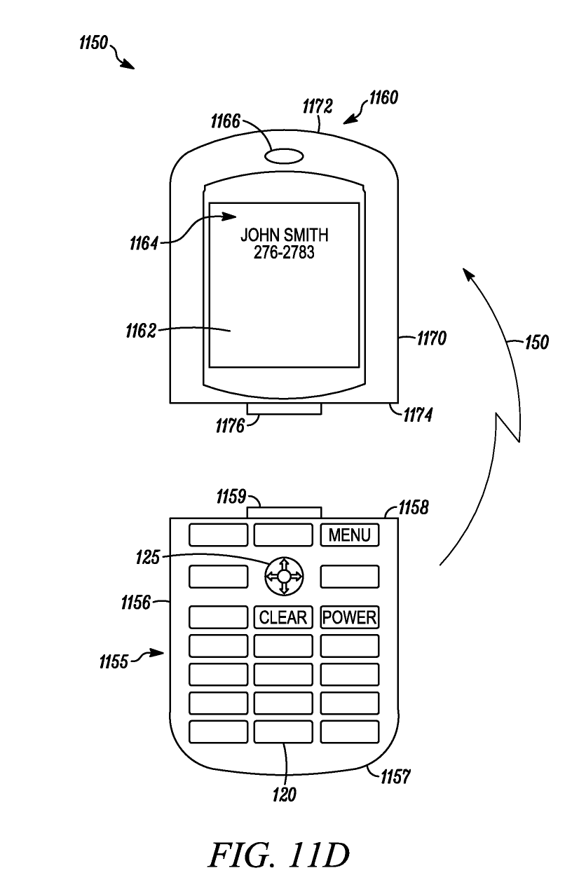

FIGS. 11A, 11B and 11C illustrate an example communication assembly 1100 that has a mobile communication device 1100 and an integrated removable remote notification device 1120. Mobile communication device 110 can be a wide variety of devices such as mobile telephones or cell phones, personal data assistants, laptop computers, email devices, pagers, tablet computers or notebook computers, etc. These devices provide various means of communication. Mobile communication device 110 includes a housing 106. Mounted in housing 106 are a display 115, a plurality of input keys 120 and a scroll device 125. Housing 106 has a front side or surface 111, back side or surface 113 and side surfaces 114. Display 115 can display a wide variety of information 118 to a user. For example, display 115 can display the name and phone number of an incoming phone call. A cavity 130 is defined in back side 112 of housing 106. Remote notification device 1120 is shaped such that it can be inserted into cavity 130 forming an integrated unit with housing 106. A pair of metal pins or connectors 132 can be mounted in cavity 132 and can mate with pins on remote notification device 1120 in order to electrically re-charge remote notification device 1120 from the battery in mobile communication device 110. Remote notification device 1120 can operate in a similar manner to remote notification device 200. Remote notification device 1120 can be programmed or have user functions selected using input keys 120 and scroll device 125 of mobile communication device 110.

Remote notification device 1120 can receive communications from mobile communication device 110 via a notification signal 150. Remote notification device 1120 includes a housing 1122 that contains an input device 1224 such as a button. A connector device such a clip (not shown) may also be attached to housing 1122 in order to attach remote notification device 1120 to a clothing garment. Housing 106 can include a latch mechanism 134 to retain remote notification device 1120 in cavity 130. A magnet 136 can be mounted in cavity 130 and can mate with other magnets (not shown) on remote communication device 1120 in order to retain remote communication device 1120 within cavity 130. Mobile communication device 110 can transmit notification signal 150 to remote notification device 1120 using a radio frequency or optical signal. Various communication standards can be used. Examples include IEEE 802.11 series, Bluetooth, IEEE 802.16 series, Zigbee and infrared. Other conventional and/or later developed communication standards may also be used. Notification signal 150 is a one way or unidirectional signal or transmission from mobile communication device 110 to remote notification device 1120. Notification signal 150 can contain a wide variety of data and information

Communication assembly 1100 can be used as a conventional mobile communication device with remote notification device 1120. Remote communication device 1120 can be attached to and removed from housing 106. In an example, mobile communication device 110 can be placed inside a handbag and remote notification device 1120 placed on the outside of the handbag and retained by a connector device or magnet. Alternatively, remote communication device 1120 can be detached and removed from housing 106 and positioned tens of feet from mobile communication device 110.

FIG. 11D illustrates an example communication assembly 1150 that has a mobile communication device 1155 and an integrated removable remote notification device 1160. Mobile communication device 1155 includes a housing 1156. Mounted in housing 1156 are a plurality of input keys 120 and a scroll device 125. Housing 1156 has bottom end 1157 and a top end 1158. Removable remote notification device 1160 includes a housing 1170 that has an upper end 1172 and bottom end 1174. Housing 1170 includes a display 1162 that can display a wide variety of information 1164 to a user. For example, display 1164 can display the name and phone number of an incoming phone call. Remote notification device 1160 can mate with mobile communication device 1155 to form a single integrated unit. Remote notification device 1160 can also be removed from mobile communication device 1155 to form a separate device that can be placed in other separate locations by a user. A connector portion 1159 can be located at end 1158 and can mate with another connector portion 1176 that is located at end 1174 in order to mechanically and electrically couple remote notification device 1160 and mobile communication device 1155. Remote notification device 1160 be recharged by the battery in mobile communication device 1155. Remote notification device 1160 can operate in a similar manner to remote notification device 200.

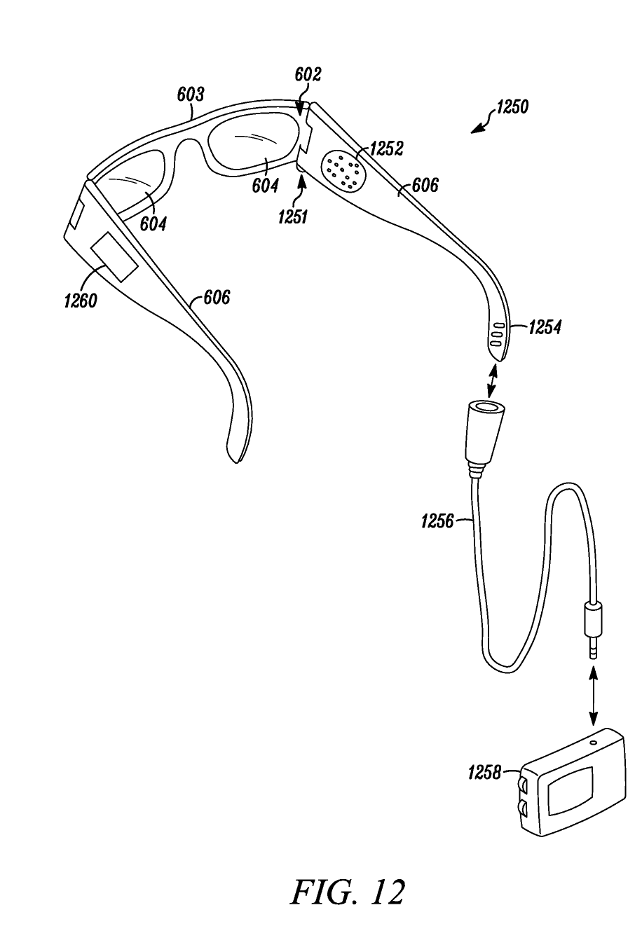

FIG. 12 illustrates an eyeglass/notifier system 1250 that includes eyeglasses with like components having like reference numbers as used above, a connection cord 1256, and a remote notification device 1258. The cord 1256 electrically connects the remote notification device 1258 to the eyeglasses at mechanical/electrical connection 1254. A microphone 1251 is positioned at the end of at least one temple 606 closely adjacent to the rim 603. In an example, the microphone 1251 can be in the rim 603 closely adjacent the temple. In an example, the microphone 1251 is at the joint or part of the pivot whereat the temple joins the rim 603. The microphone 1251 can pick up the voice or other ambient sounds and record those into wither memory in the eyeglasses themselves or back to the remote notification device 1258. A speaker 1252 can be positioned in the temples 606 of the glasses. The speaker 1252 can generate sounds to either playback recordings from the microphone or provide notifications from the remote notification device 1258. In an example, the speaker 1252 outputs a notification to notify, alert or display information to the user as discussed herein. In an example, a display 1260 can be provided that displays the same information that remote notification device 1258 shows. In an example, the display 1260 is one or more light emitting diodes that can alert the user by illuminating or blinking a pattern. In an example, the display 1260 can be a liquid crystal display. The display 1260 can provide indications or information to the user.

In an example, the remote notification device 1258 includes electrical components for selecting a multimedia asset to play through the cord 1256 and the speaker 1252 or and/or display. In an example, the notification device 1258 is also a portable music player. While shown as a wired or physical connection through cord 1256, it is within the scope of the present invention to provide wireless communication between the glasses and the remote notification device 1258.

Other examples of eyeglasses that can incorporate the remote notification apparatus, methods and systems as described herein include U.S. Pat. Nos. 6,929,365; 7,073,905; 7,331,666; 7,401,918; 7,438,410; 7,500,747; 7,603,078; and 7,758,185; and US Patent Publication Nos. 2005/0248722, which are hereby incorporated by reference for any purpose and are to be treated as part of this disclosure. Other examples of devices that may relate to apparatus, methods and systems as described herein include U.S. Pat. Nos. 5,007,105; 6,954,659; 7,177,664; 7,203,331; and 7,769,412, which are hereby incorporated by reference for any purpose and are to be treated as part of this disclosure. However, if a conflict of ambiguity of meaning arises between the present subject matter and the subject matter incorporated by reference occurs, the present document controls the interpretation.

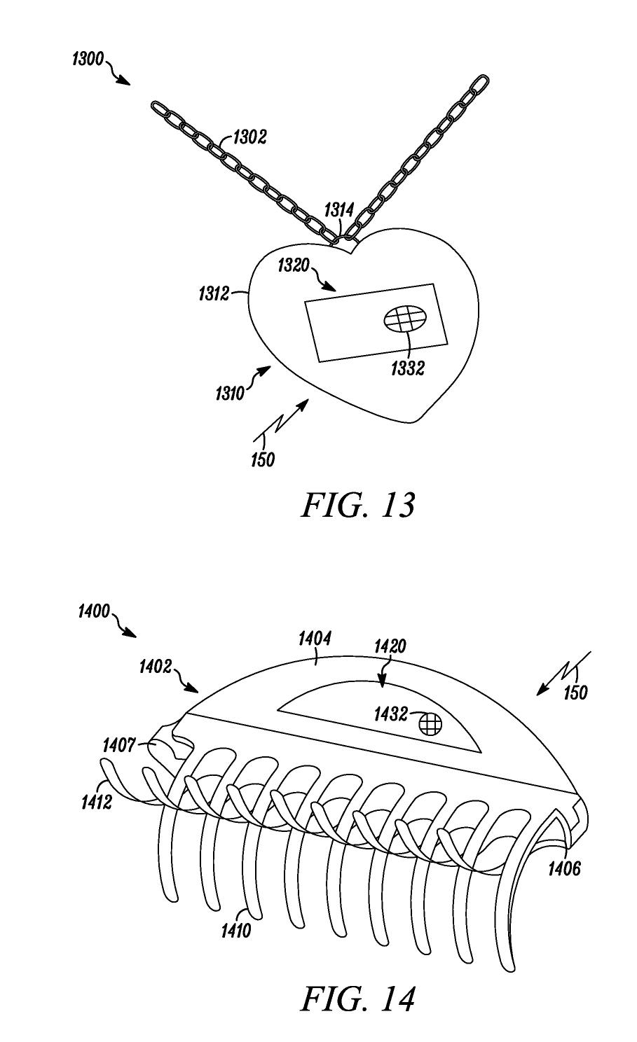

FIG. 13 illustrates a necklace assembly 1300 that contains a remote notification device 1320. Remote notification device 1320 can be integrated into a locket 1310 that is attached to a chain or beads 1302. Chain or beads 1302 can be attached around the neck of a user in a manner where the remote notification device is not noticeable. Locket 1310 can include a body 1312 in a decorative shape and a connector 1314. Connector 1314 connects locket 1310 to chain 1302. Chain 1302 and locket 1310 can be formed of any suitable material such as plastic or metal. Remote notification device 1320 can be integrated or mounted in body 1312. Remote notification device 1320 can include a speaker 1332. Remote notification device 1320 can also contain a vibration mechanism 414 (FIG. 4) or an input device 220 (FIG. 4). Remote notification device 1320 can operate in the same manner as remote notification device 200 upon receipt of notification signal 150. Necklace assembly 1300 can have a small overall size and can be worn under clothing such that it is unnoticeable.

FIG. 14 illustrates a hairclip assembly 1400 that contains a remote notification device 1420. Remote notification device 1420 can be integrated into hairclip 1402 that can be attached in to the hair of a user in a manner where the remote notification device is not noticeable. Hairclip 1402 can include a pair of opposed bodies 1404 and 1406 that are biased toward each other by a spring mechanism 1407. Tangs 1410 and 1412 mesh with each other over the hair of a user in order to hold the hair of a user. Hairclip 1402 can be formed of any suitable material such as plastic or metal. Remote notification device 1420 can be integrated or mounted in body 1404. Hairclip assembly can be attached or detached from the hair of a user. Remote notification device 1420 includes a speaker 1432. Remote notification device 1420 can also contain a vibration mechanism 414 (FIG. 4) or an input device 220 (FIG. 4). Remote notification device 1420 can operate in the same manner as remote notification device 200 upon receipt of notification signal 150. Hairclip assembly 1400 can have a small overall size such that when attached to the hair of a user, hairclip assembly 1400 is undetectable to others who are in view of the user.

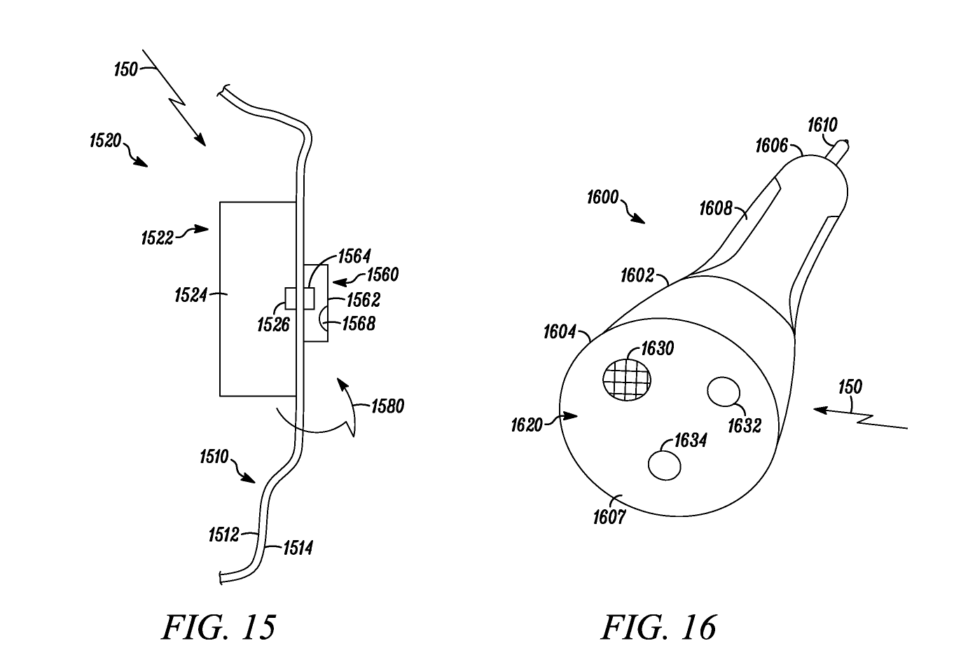

FIG. 15 illustrates a remote notification device 1520 with a detachable indicator 1560. Remote notification device 1520 includes a housing 1524 with a magnet 1526. Magnet 1526 can be positioned adjacent an outside surface of housing 1524. Indicator 1560 includes a housing 1562 with a magnet 1564. Magnet 1564 can be positioned adjacent an outside surface of housing 1562. Remote notification device 1520 can be placed on the inside surface 1512 of a purse or handbag 1510 with detachable indicator 1560 positioned on the outside surface 1514 of the handbag. Magnets 1526 and 1564 can retain remote notification device 1520 and detachable indicator 1560 together on purse 1510. Detachable indicator 1560 can have a small overall size such that the detachable indicator is not noticeable or is inconspicuous. Detachable indicator 1560 includes a speaker 1568. Remote notification device 1560 can also contain a vibration mechanism 414 (FIG. 4) or a light 412 (FIG. 4). Alternatively, speaker 1560 can be omitted. When remote notification device 1520 receives a notification signal 150, it sends a wireless indicator signal 1580 to indicator 1560. Upon receipt of the wireless indicator signal 1580, indicator 1560 proceeds to issue an alert to the user of an incoming call using a visual, audio or vibrating alert as selected by the user. Operating modes of detachable indicator 1560 can be selected by programming using remote notification device 1560. Detachable indicator 1560 can include a battery and be recharged by connecting with remote notification device 1560. Alternatively, detachable indicator 1560 may not include a battery and is powered by electro-magnetic coupled charge from remote notification device 1560.

FIG. 16 illustrates a vehicle cigarette lighter assembly 1600 that contains an integrated remote notification device 1620. Remote notification device 1620 can be integrated into vehicle cigarette lighter assembly 1600. Vehicle cigarette lighter assembly 1600 plugs into the receptacle of a vehicle cigarette lighter assembly, when the lighter is removed. Vehicle cigarette lighter assembly 1600 can include a housing 1602 that has opposed ends 1604 and 1606 and a front face 1607. Housing 1602 can be formed of any suitable material such as plastic. Connectors 1608 and 1610 are mounted to housing 1602 and can connect with the lighter receptacle in order to provide power to remote notification device 1620. Remote notification device 1620 can include a speaker 1630, light 1632 and input device such as button 1634. Remote notification device 1620 can also contain a vibration mechanism 414 (FIG. 4). a vehicle cigarette lighter assembly 1600 an operate in the same manner as remote notification device 200 upon receipt of notification signal 150. Remote notification device 1620 can provide an alert to the occupant of a vehicle that there is an incoming phone call or message.

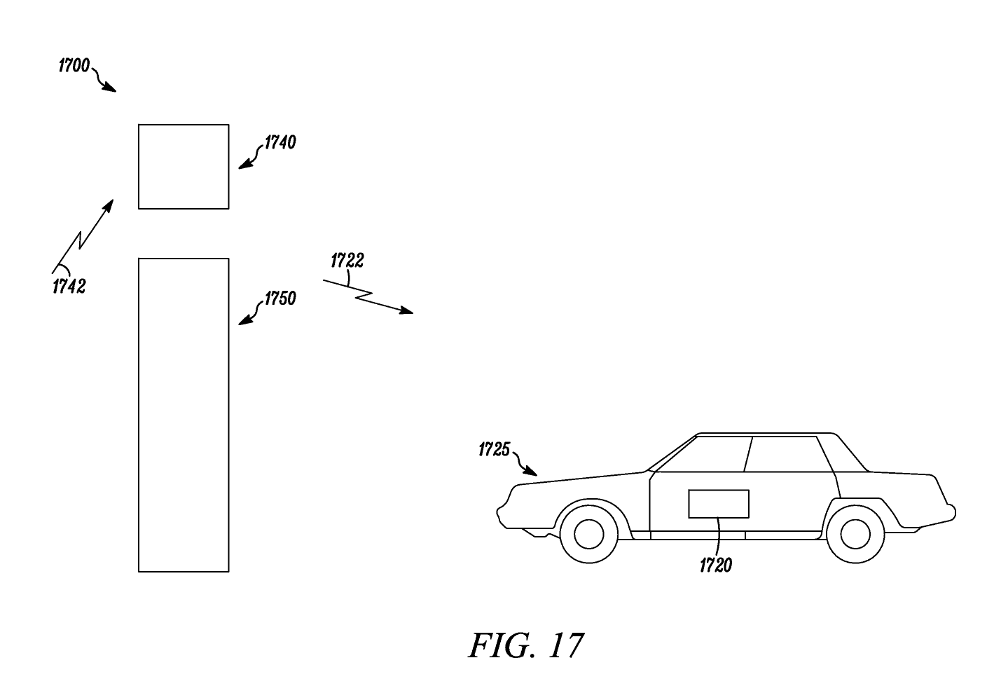

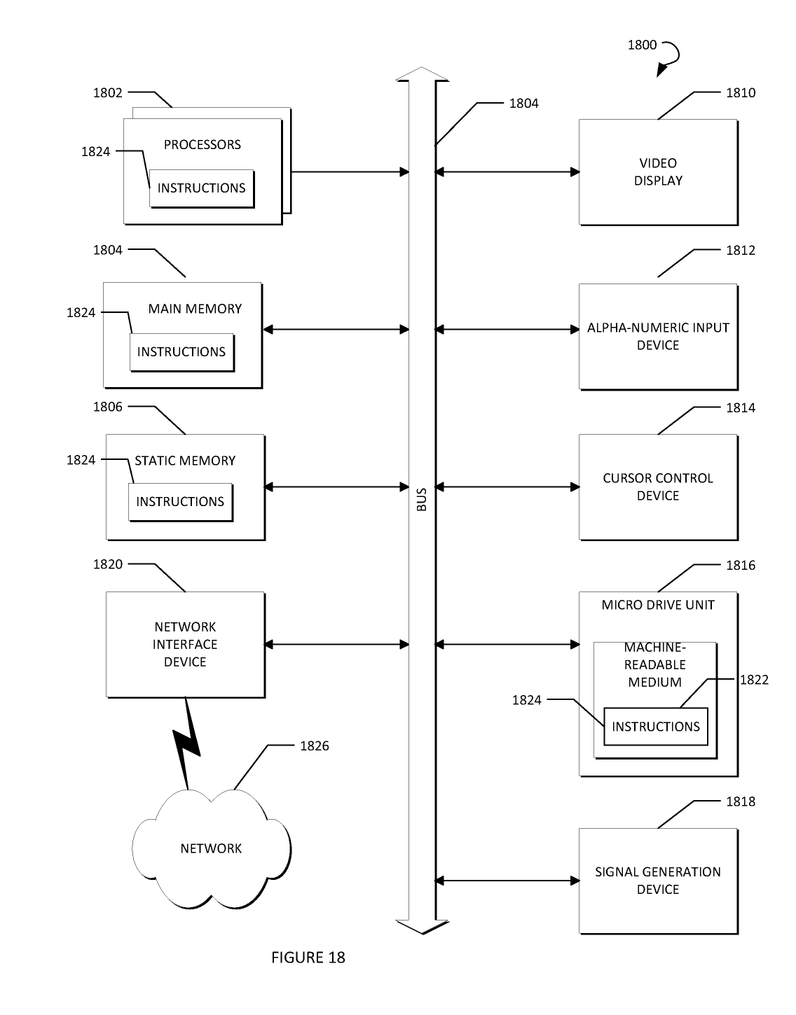

FIG. 17 illustrates a system 1700 with multiple remote notification devices. Two or more remote notification devices can be located in the same area and can be programmed or assigned different priorities. A first remote notification device has a higher priority than a second remote notification device. First remote notification device 1720 can be associated with a vehicle 1725 and have a higher priority over a second remote notification device 1740 that is associated with a portable mobile communication device 1750. Remote notification device 1720 can receive a notification signal 1722 and remote notification device 1740 can receive a notification signal 1742. In the vicinity of the vehicle 1725, the first remote notification device 1720 is functional and the second remote notification device 1740 is disabled. If the second remote notification device 1740 is removed from the vicinity of the vehicle 1725, the second remote notification device 1740 can become functional and resume normal operation. Each of the multiple notification devices has the ability to register with an associated mobile communication device and can be assigned multiple levels of priority by the user. Software that operates on controller 402 (FIG. 4) can determine which remote notification device has priority depending on the location of each remote notification device.

In an example, remote notification device 1720 can register with mobile communication device 1750, and remote notification device 1740 can register with both mobile communication device 1750 and remote notification device 1720. When remote notification device 1720 is in the vicinity of remote notification device 1740. System 1700 can instruct remote notification device 1740 to stay quiet. At this time, control of the ringing and monitoring of mobile communication device 1750 is transferred to the remote notification device 1720. After remote notification device 1740 is removed from the vicinity of remote notification device 1740, the monitoring and the control of mobile communication device 1750 is transferred to remote notification device 1740. In an example, remote notification device 1740 can set off an alarm when remote notification device 1740 travels out of range and losses communication with mobile communication device 1750. For example, if a user leaves mobile communication device 1750 in an area and travels away from the area carrying remote notification device 1740, an alarm may be generated. This can occur if the remote notification device 1740 travels beyond the signal range of notification signal 1742. After the alarm is generated, the user can either travel back within range of notification signal 1742 or silence the alarm.

The remote notification device 200, 560, 620, 720, 820, 860, 920, 1160, 1250, 1320, 1420, 1520, 1620, 1720, 1740 can be programmed to ignore some previously identified calls. The previously identified calls can be selected based on the numbers of the caller, the caller's name or other identification information. The identified calls can also be repeat numbers that the remote notification device has previously notified the user but the user has chosen to ignore. These ignored calls can be stored in the memory of the remote notification device or the memory of the mobile communication device (phone). The ignored calls list in memory can be deleted after a period of time or by action of the inputs on the remote communication device. In an example, the ignored call list is erased at a certain time each day, for example, midnight. In an example, the ignored call list is erased when a sequence of input buttons or switches are pressed on the remote notification device. In an example, the ignored call list is erased when a call is answered by the user. In an example, the ignored call list is erased from in the mobile communication device when a call is answered.

The remote notification device 200, 560, 620, 720, 820, 860, 920, 1160, 1250, 1320, 1420, 1520, 1620, 1720, and/or 1740 can be programmed to notify only if a call is identified as an approved notification call. A call can be checked against a list of approved number(s) of other identification. This list can be stored in memory of the remote notification device. This list can be programmed by a remote electronic device, such as a computing device or the mobile communication device, or by the input into the remote notification device itself. In an example, the remote notification device is programmed to stay silent and only notify the user on some previously identified call, which can be on the notification list.

FIG. 14 shows a diagrammatic representation of a computing device for a machine in the example electronic form of a computer system 1400, within which a set of instructions for causing the machine to perform any one or more of the methodologies discussed herein can be executed. In various example embodiments, the machine operates as a standalone device or can be connected (e.g., networked) to other machines. In a networked deployment, the machine can operate in the capacity of a server or a client machine in a server-client network environment, or as a peer machine in a peer-to-peer (or distributed) network environment. The machine can be a personal computer (PC), a tablet PC, a set-top box (STB), a Personal Digital Assistant (PDA), a cellular telephone, a portable music player (e.g., a portable hard drive audio device such as an Moving Picture Experts Group Audio Layer 3 (MP3) player, a web appliance, a network router, a switch, a bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

An example remote notification device 1800 can include a processor or multiple processors 1802 (e.g., a central processing unit (CPU), a graphics processing unit (GPU), programmable gate array, or combinations thereof), and a main memory 1804 and a static memory 1806, which communicate with each other via a bus 1808. The remote notification device 1800 can further include a video display unit 1410 (e.g., a liquid crystal display (LCD)). The computer system 1800 also includes an alphanumeric input device 1812 (e.g., a keyboard or buttons), a cursor control device 1814 (e.g., a mouse, buttons, pointer, screen touch interface, etc.), a microdrive unit 1816, a signal generation device 1818 (e.g., a speaker) and a network interface device 1820.

The microdrive unit 1816 includes a computer-readable medium 1822 on which is stored one or more sets of instructions and data structures (e.g., instructions 1824) embodying or utilized by any one or more of the methodologies or functions described herein. The instructions 1824 can also reside, completely or at least partially, within the main memory 1804 and/or within the processors 1802 during execution thereof by the remote notification device 1800. The main memory 1804 and the processor 1802 also constitute machine-readable media.

The instructions 1824 can further be transmitted or received over an electronic or optical network 1826 via the network interface device 1820 utilizing any one of a number of well-known transfer protocols (e.g., Hyper Text Transfer Protocol (HTTP), CAN, Serial, or Modbus).

While the computer-readable medium 1822 is shown in an example embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media can also include, without limitation, hard disks, floppy disks, flash memory cards, digital video disks, random access memory (RAMs), read only memory (ROMs), and the like.

The present inventor recognized that, unfortunately, there are many situations where the ring tone is disruptive to others or when the user does not wish to alert others that they are receiving a call. For example, a mobile phone user in a meeting or a public gathering may not want to disturb the meeting or gathering with audible ringing or vibrations from a conventional mobile and at the same time desire to know if any calls or messages are received. If the mobile communication device is located in a handbag and vibrates to indicate an incoming call, the user may not be altered to the call if the handbag absorbs the vibrations. When the user places the mobile communication device in a further carrying bag, e.g., purse, backpack, valise, computer case, totes, briefcase, etc., the mobile phone may not be close enough to alert the user through the carrying bag. Accordingly, the present inventor invented the remote notification device or remote ringer as described herein.

The present apparatus, methods and systems described herein can provide a discrete alert of an incoming call to a mobile phone user in situations where it is not possible or inconvenient for the mobile phone user to use their mobile phone in a normal manner. For example, a mobile phone user in a meeting may not want to disturb the meeting with audible ringing or vibrations from a conventional mobile phone and at the same time desire to know if any calls or messages are received. The apparatus and methods of the present invention provide a discrete and covert alert to a user of incoming calls and messages without being a distraction or drawing the attention of others in the vicinity. In an example and in conjunction with all of the embodiments described herein the remote notification device is portable and available for mobile communication with a mobile communication device.

The present apparatus, methods and systems described herein can further provide health benefits by moving the mobile communication device (e.g., a cellular telephone) farther from the user's body and possibly reducing adverse health effects that the mobile communication device can have on the user. In an aspect of the present invention, the remote notification device does not transmit an electromagnetic signal. It merely receives or senses a signal or signals from the remote communication device. As a result, the user, when using the remote notification device, will be subject to a lower level of electromagnetic energy. The present apparatus, methods and systems can provide the greatest benefit when a user uses a mobile communication a significant period of time, e.g., greater than an hour per day, greater than three hours per day, greater than eight hours per day, etc. by moving the broadcast, wireless device farther from the user's body.

It is noted that the European Commission Scientific Committee on Emerging and Newly Identified Health Risks (SCENIHR) issued an assessment in 2007 that concluded, viz. animal, in vitro, and epidemiological studies, “exposure to RF fields is unlikely to lead to an increase in cancer in humans.” SCENIHR states that further studies are required to identify whether considerably longer-term (well beyond ten years) human exposure to such phones might pose some cancer risk. Nonetheless, storing the mobile communication device remote from the user as described herein will reduce radiation exposure to the user.

Aspects of the embodiments were shown mounted in and to various components such as housings that can be attached to or embedded in articles worn or closely held by a user. These common items can include eyeglass frames, watches, necklaces, jewelry, and earpieces. Other types of articles can include handbags, clutches, briefcases, backpacks, satchels, purses, or clothing. In an example, the remote ringer described herein can be integrated into a garment, such as a hat or a scarf. Many other packaging configurations are contemplated in which the present invention can be implemented. In many of these packaging configurations the remote notification device is hidden from sight or essentially hidden from sight so that only the user will typically know where the remote notification device is located. The remote notification device can be beneath clothes, embedded between layers of clothes, affixed to the outside of an accessory, e.g., by a magnet, or otherwise close to the user. As a result, the remote ringer, e.g., the housing thereof, is near, on or attached to a user in an inconspicuous manner.

An example of the present remote communication device can include a means for housing the electronic components of the device, to be near, on or attached to a user in an inconspicuous manner, a means for receiving; a notification signal from a mobile communication device, the means for receiving being the only means of communication with the remote notification device wherein the remote notification device is in unidirectional communication with the mobile communication device using a bidirectional or unidirectional communication protocol, and an means for indicating receipt of the notification signal to a user of the remote notification device with the mobile communication device being remote from the remote notification device.

Although the present invention has been described with reference to specific example embodiments, it will be evident that various modifications and changes can be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. A remote notification device, comprising:
a housing to be near, on or attached to a user in an inconspicuous manner;
a receiver contained in the housing, the receiver to receive a notification signal from a mobile communication device, the receiver being the only means of communication with the remote notification device wherein the remote notification device is in unidirectional communication with the mobile communication device using a bidirectional or unidirectional communication protocol; and
an indicator coupled to the housing, the indicator to indicate receipt of the notification signal to a user of the remote notification device with the mobile communication device being remote from the remote notification device.

2. The remote notification device according to claim 1, wherein the receiver receives a display signal that includes information representing a display on the mobile communication device, the display on the mobile communication device being remote from the notification device; wherein the housing includes a notifying display that uses the display signal to display at least some of the same information as displayed on the display of on the remote, mobile communication device.

3. The remote notification device according to claim 2, wherein the notifying display shows the same image as shown on the display of the mobile communication device, and wherein the notifying display is free from interactive controls with the user.

4. The remote notification device claim 1, wherein the housing is positioned outside a garment or carrying bag with the mobile communication device being within one of the garment or carrying bag.

5. The remote notification device according to claim 1, wherein the housing is positioned on the inside of undergarments and the mobile communication device being carried away from any of clothing on the user.

6. A remote notification system, comprising:
a mobile communication device adapted to receive an incoming communication;
a remote communication device coupled to, attached to, and removable from the mobile communication device,
a receiver coupled to the remote communication device housing, the receiver adapted to receive a notification signal from the mobile communication device; and
an indicator coupled to the remote communication device, the indicator adapted to alert a user to the incoming communication.

7. The remote notification system according to claim 6, wherein the remote communication device is attached to the mobile communication device by a magnet.

8. The remote notification system according to claim 6, wherein the remote communication device is programmed through the mobile communication device.

9. A remote notification device, comprising:
an assistive device;
a receiver coupled to the assistive device, the receiver adapted to receive a notification
signal from a mobile communication device; and
an indicator coupled to the assistive device; the indicator adapted to indicate receipt of the notification signal to a user of the assistive device.

10. The remote notification device according to claim 9, wherein the assistive device is a hearing aid.

11. The remote notification device according to claim 9, wherein the receiver is adapted to receive voice communication streams from the mobile communication device.

12. The remote notification device according claim 9, wherein the assistive device receives the incoming communication transmission from the mobile communication device and transmits it through the hearing device to the user, and mobile communication device receives the outgoing voice communication through its microphone and transmits it out to the other side.

13. The remote notification device according to claim 9, wherein the assistive device includes a speaker and the receiver is configured to receive a voice signal that is transmitted to the speaker.

14. A remote notification device, comprising:
a housing;
a receiver coupled to the housing, the receiver configured to receive a notification signal from a mobile communication device;
an indicator coupled to the housing, the indicator to indicate receipt of the notification signal to a user of the remote notification device with the mobile communication device being remote from the remote notification device;
an attachment mechanism coupled to the housing, the attachment mechanism allowing the user to carry the remote notification device in an inconspicuous manner.

15. The remote notification device according to claim 14, wherein the attachment mechanism is a clip.

16. The remote notification device according to claim 14, wherein the housing is adapted to be placed adjacent to the skin of a user.

17. The remote notification device according to claim 14, wherein the indicator is a vibrating mechanism.

18. The remote notification according to claim 14, wherein the indicator is an audible tone.

19. The remote notification system according to claim 14, wherein the remote communication device includes hearing aid circuitry and can emit an alert signal to a wearer of the hearing aid circuitry.

20. The remote notification system according to claim 14, wherein the remote communication device includes eyeglasses and circuitry in the eyeglasses to emit an alert signal to a wearer of the eyeglasses.

21. The remote notification system according to claim 20, wherein the eyeglasses include an audio tube extending to a wearer's ear to delivery an audio signal to the wearer's ear.

22. A remote notification device, comprising:
a first housing;
a receiver mounted in the first housing, the receiver configured to receive a notification signal from a mobile communication device and to transmit an indicator signal;
a second housing; and
an indicator mounted in the second housing, the indicator adapted to receive the indicator signal and to provide an alert.

23. The remote notification according to claim 22, wherein the first and second housings are physically coupled by one or few magnets.

24. The remote notification device according to claim 22, wherein the indicator signal is communicated to the indicator wirelessly.

25. A remote notification system, comprising:
a first remote notification device adapted to receive a first notification signal from the mobile communication device, the first remote notification device being mobile and portable;
a second remote notification device adapted to receive a second notification signal from the mobile communication device, the second remote notification device being mobile and portable; and
software operable on the system to determine which of the first or second remote notification devices has priority.

26. The remote notification device according to any of the above claim 1, wherein the housing includes a power source, and wherein the power source includes at least one of a rechargeable battery, a replaceable battery, a power input to connect to an external power supply, an inductive power source, and a kinetic power source.

27. The remote notification device according to claim 1, wherein the housing includes an input device to establish communication link with the mobile communication device.

28. The remote notification device according to claim 1, wherein the housing includes a connector to affix to a wearable garment to secure the device to the garment and place the device against the body of the user.

29. The remote notification device according to claim 1, wherein the housing includes a connector to affix to wearable accessory such as eyeglasses, bracelet, wristwatch, or hat.

30. The remote notification device according to claim 1, wherein the indicator includes a vibration device that can be sensed by a user.

31. The remote notification device according to claim 1, wherein the indicator includes a speaker for sounding a sequence of tones or music, or a buzzer or beeper for sounding a predetermined tone.

32. The remote notification device according to claim 1, wherein the indicator includes an audio tube connecting to a wearer's ear.

33. The remote notification device according to claim 1, wherein the housing includes a watch.

34. The remote notification device according to claim 1, wherein the housing is remote from the mobile communication device, preferably at least inches away from the mobile communication device and at most tens of feet from the mobile communication device.

35. The remote notification device according to claim 1, wherein the housing has overall dimensions that are less than 1.5 inches along any axis.

36. The remote notification device according to claim 1, wherein the housing includes at least one of a hairclip, necklace, hearing aid, eyeglasses, analog watch, digital watch, cigarette lighter plug and watchband link or combinations thereof.

37. The remote notification device according to claim 1, wherein the indicator is a vibration device having a plurality of vibration levels that can be selected by the user.

38. The remote notification device according to claim 1, wherein the housing includes an attachment mechanism that allows the remote notification device to be attached under a garment.

39. The remote notification device according to claim 1, wherein the housing includes an attachment mechanism that allows the remote notification device to be attached outside a garment.

40. The remote notification device according to claim 1, wherein the housing includes a connection plug allowing the device to be connected to a computer for programming.

41. The remote notification device according to claim 1, wherein the housing includes a switch that is used for programming different features in the device using various sequences of press/release in conjunction with time delays.

42. The remote notification device according to claim 1, wherein the device can be programmed to ignore some previously identified calls.

43. The remote notification device according to claim 1, wherein the device can be programmed to stay silent and only notify the user on some previously identified call.

44. The remote notification device according to claim 1, wherein the device can be programmed to vibrate or sound differently for different groupings of calls.

45. The remote notification device according to claim 1, wherein the device can be programmed via the mobile communication device interface.

46. The remote notification device according to claim 1, wherein the remote communication device emits a warning signal when it is apart from the mobile communication device at a distance predetermined by the user.

47. The remote notification device according to claim 1, wherein the mobile communication device emits a warning signal when it is apart from the remote notification device at a distance predetermined by the user.

48. The remote notification device according to claim 1, wherein the mobile communication device emits a warning signal when the communication link with the remote communication device is terminated due to distance or interruptions in wireless communication.

49. The remote notification device according to claim 1, wherein the remote communication device emits a warning signal when the communication link with the mobile communication device is terminated due to excessive distance, or interruptions in wireless communication.
